(19) United States
(12) Patent Application Publication
(10) Pub. No.: US 2018/0235254 A1
(43) Pub. Date: Aug. 23, 2018

(54) Stick Spout Pouch and Cap Stick for Frozen Confections

(71) Applicant: Global Italian Ices Inc., Valley Stream, NY (US)

(72) Inventors: Gregory BROCCOLI, Coral Springs, FL (US); Maria ARENA, Brooklyn, NY (US); Peter GROSZ, Woodmere, NY (US); John RUSSO, Brooklyn, NY (US)

(73) Assignee: Global Italian Ices Inc., Valley Stream, NY (US)

(21) Appl. No.: 15/446,549

(22) Filed: Mar. 1, 2017

Related U.S. Application Data
(60) Provisional application No. 62/462,762, filed on Feb. 23, 2017.

(51) Int. Cl. A23G 9/50; B65D 85/78; B65D 41/04; B65D 51/24; B65B 3/04; B65B 55/06

(52) U.S. Cl. CPC A23G 9/503; B65D 85/78; B65B 55/06; B65D 51/24; B65B 3/04; B65D 41/04

(57) ABSTRACT

A confection containing device that contains a confection consumed frozen. The device includes a stick-spout-pouch assembly, and a stick cap. The stick-spout-pouch assembly includes a latching portion integral with a stick portion, and a pouch bag attached to the latching portion. The stick cap attaches to the latching portion of the stick-spout-pouch assembly. The pouch bag contains a confection in a non-frozen state surrounding the stick portion of the stick-spout-pouch assembly. The pouch bag of the stick-spout-pouch assembly is sealed to the latching portion of the stick-spout-pouch assembly. The stick cap attaches to the latching portion of the stick-spout-pouch assembly by a sealed connection. Further, the pouch bag is filled with the confection in a liquid state through at least one opening on the stick-spout-pouch assembly. The opening is on the latching portion of the stick-spout-pouch assembly.

### CROSS REFERENCE TO RELATED APPLICATIONS

This application claims the benefit of U.S. Provisional Patent Application No. 62/462,762, filed on Feb. 23, 2017, the disclosure of which is hereby incorporated by reference in its entirety.

### TECHNICAL FIELD

The present invention relates to a stick-spout-pouch for frozen confections and its manufacturing method. Specifically, the present invention relates to a plastic ice bar stick for frozen confections with a manufacturing method of injecting ingredients for frozen confections through a narrow plastic stick which is attached to the spout of the pouch.

### BACKGROUND

Conventional ice cream manufacturing technology produces ice cream or Italian Ice that requires freezer refrigeration. In addition, many manufactures use preservatives and artificial coloring to produce a frozen confection such as a fruit bar. Most confection producing companies manufacture the frozen confections and warehouse the product until it needs to be shipped to a distributor. At that stage, the distributor stores the product until it is shipped to a retailer. This cycle of maintaining a frozen state without a single degree of variance in temperature is logistically difficult and inefficient.

In this chain of delivery it is almost certain that the content of the frozen confection, delivered by the manufacturer for consumption, has been altered in the process. The change in the content occurs due to temperature fluctuations, which affect the quality of the consumed product. To make the product and maintain its quality without the expense of constant freezer refrigeration is the most challenging component of the quality control process of making and selling ice cream or Italian Ice.

Therefore, there is a need for a technique that allows for a confection that is normally consumed frozen to be delivered to a retailer in a stable and non-frozen state in order for the raw materials to not require freezing during transportation or storage. Such a technique would avoid the conventional injecting of the ingredients into a batch freezer and/or ice molds.

### SUMMARY

The presently disclosed subject matter relates to a confection containing device that contains a confection consumed frozen. In one embodiment, the confection containing device comprises a stick-spout-pouch assembly, and a stick cap, wherein the stick-spout-pouch assembly includes: a latching portion integral with a stick portion, and a pouch bag attached to the latching portion, wherein the stick cap attaches to the latching portion of the stick-spout-pouch assembly, and wherein the pouch bag contains a confection in a non-frozen state surrounding the stick portion of the stick-spout-pouch assembly.

The pouch bag of the stick-spout-pouch assembly may be sealed to the latching portion of the stick-spout-pouch assembly. The stick cap may attach to the latching portion of the stick-spout-pouch assembly by a sealed connection. Further, the pouch bag may be filled with the confection in a liquid state through at least one opening on the stick-spout-pouch assembly. The at least one opening may be on the latching portion of the stick-spout-pouch assembly.

Moreover, the non-frozen confection may change state of aggregation from liquid to solid (frozen) when exposed to a freezing temperature. The pouch bag may peel off of the stick-spout-pouch assembly when the confection is frozen. The confection may be supported by the stick portion of the stick-spout-pouch when the pouch bag is peeled off. The stick cap may be shaped to be elongated for holding the confection containing device by hand when the confection is frozen. In addition, the stick portion may be shaped to be an elongated stick or to be an elongated cylinder. The stick portion of the stick-spout-pouch assembly may include at least one aperture or at least one groove. Components of the confection containing device may be made of plastics.

Additionally, the at least one opening on the stick-spout-pouch assembly may communicate with an opening parallel to a longitudinal axis of the stick-spout-pouch assembly and an opening perpendicular to the longitudinal axis of the stick-spout-pouch assembly. The pouch bag may be elliptical, substantially circular, or rectangular.

In another embodiment, a confection containing device comprises a stick-spout-pouch assembly, wherein the stick-spout-pouch assembly includes a latching portion integral with a stick portion, and a pouch bag attached to the latching portion, wherein the stick-spout-pouch assembly includes an opening allowing confection product, in a liquid state, to be introduced into the pouch bag and surround the stick portion. Further, another example of the present invention is a method of making a confection that is sold in stores, comprising: blending confection ingredients in a supplying unit and supplying the confection ingredients to a mixing tank; pumping a mixture from the mixing tank to a plurality of filling stations; filling a plurality of sealed pouches with the mixture pumped into the plurality of filling stations; transporting the plurality of sealed pouches through a hot sterilization unit; drying the plurality of sealed pouches by a cooler dryer; and storing the plurality of sealed pouches in a storage unit.

### BRIEF DESCRIPTION OF THE DRAWINGS

FIG. 1 is a schematic view of a spout stick and pouch where the pouch is bar shaped.

FIG. 2 is a schematic view of a cap stick and a cross section of spout stick seen in the pouch of FIG. 1.

FIG. 3 is a three-dimensional view of a spout stick sealed with a cap stick to lock and seal.

FIG. 4 is a schematic view of a spout stick pouch where the pouch is character shaped.

FIG. 5 is a schematic view of a spout stick pouch where the pouch is rocket shaped.

FIG. 6 is a flow chart diagram of a manufacturing method of a spout stick pouch.

FIG. 7 is a schematic of an opening technique of a pouch bag that includes a gusset.

FIG. 8 is a schematic of an opening technique of a pouch bag along perforated lines.

FIG. 9 is a schematic view of a cap stick and a spout stick assembly.

### DETAILED DESCRIPTION

The presently disclosed subject matter provides a structure for containing confection ingredients to be consumed frozen. The structure is preferably intended for a confection, but is not intended to be so limited; rather, it is contemplated that other contents capable of changing states of aggregation are within the scope of the presently disclosed subject matter. It is intended that the presently disclosed subject matter may be used at any location where raw ingredient transportation or storage normally occurs at the site.

Recently, manufactured baby food, beverages or milk shakes are injected into a spout pouch and sold to consumers. According to an embodiment of the present invention, the spout pouch is easily peeled apart and converts to a frozen dessert stick to be held on the base by hand to consume. The frozen confection stick spout pouch has significant advantages over existing bar types of ice cream products. The contents of the spout pouch stick may be manufactured to be sold non-frozen prior to the consumer freezing the contents, such as gourmet Italian Ice products. Products using such a spout pouch may be different from general Italian Ice.

Generally, in the art, Italian Ice is produced by utilizing a process called batch making or by injecting ingredients into molds that freeze into solid bars during manufacturing. The frozen Italian Ice bars and/or Gelato are then transported to their final destination for sale to the consumer. At all times, the Italian Ice bars must be maintained in their frozen state until purchased by the consumer.

The U.S. Food & Drug Administration and the supervisory office of food devices daily products have approved the process of mixing ingredients and inflating the amount of air in products (also known as over run) can only be applied to ice cream and not to the traditional Italian Ice. The traditional use of a batch freezer for Italian Ice and all ice creams in their manufacture includes injecting raw materials of Italian Ice and air into a product container through a freezer under constant freezing temperature and pressure irrespective of their size. The working temperature of the overrun process has conventionally been −30 to 50° F. At this time, the amount of overrun, which is a volume ratio relative to the raw materials of Italian Ice, is previously determined depending on the product grade. This process had traditionally required freezing the contents from manufacturing to distribution and retail sales.

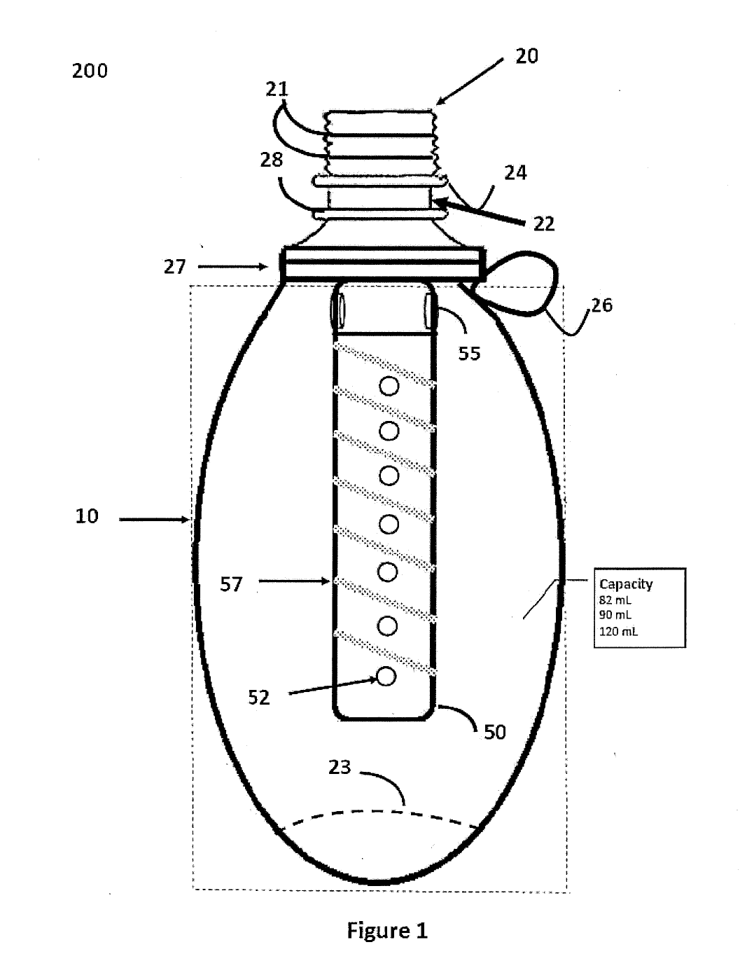

On the other hand, one embodiment of the present invention is an ice cream “stick spout” pouch assembly 200, primarily comprising a pouch bag 10 and an ice cream “stick spout” 20 fixed to the upper end of the pouch bag 10 as shown in FIG. 1. The pouch assembly may further include an upper pouch coupling 24 with a lock notch 21 used for attachment with other structures, and a latching part 22, which may be a neck part formed between a lower pouch coupling 28 and the upper pouch coupling 24. A spout stick base 27 may be formed on a lower portion of the spout stick closure. A zip tab opener 26 may be used to pull the pouch bag 10 open immediately prior to consumption leading to an easy peel away tab 23. Thereby, the opener 26 and the tab 23 may peel the pouch bag 10 from the stick spout 20 leaving only the cap stick 58 and the frozen Italian Ice or juice ready for consumption.

An ice stick 50 may be integral to the stick spout 20 and it may feature distal spot apertures 55, ice stick apertures 52 and ice stick ribs 57. The distal spot apertures 55 may provide a path for the ingredients to be poured into the pouch bag 10. In the alternative, the apertures 55 may be an additional, horizontal path for the liquid ingredients, filling the bag 10 in concert with a vertical filling path straight down the ice stick 50. The ice stick apertures 52 and the ice stick ribs 57 may provide resistance between the future frozen content of the pouch bag 10 and the ice stick 50, thereby preventing inadvertent sliding and separation of the edible content from the stick 50.

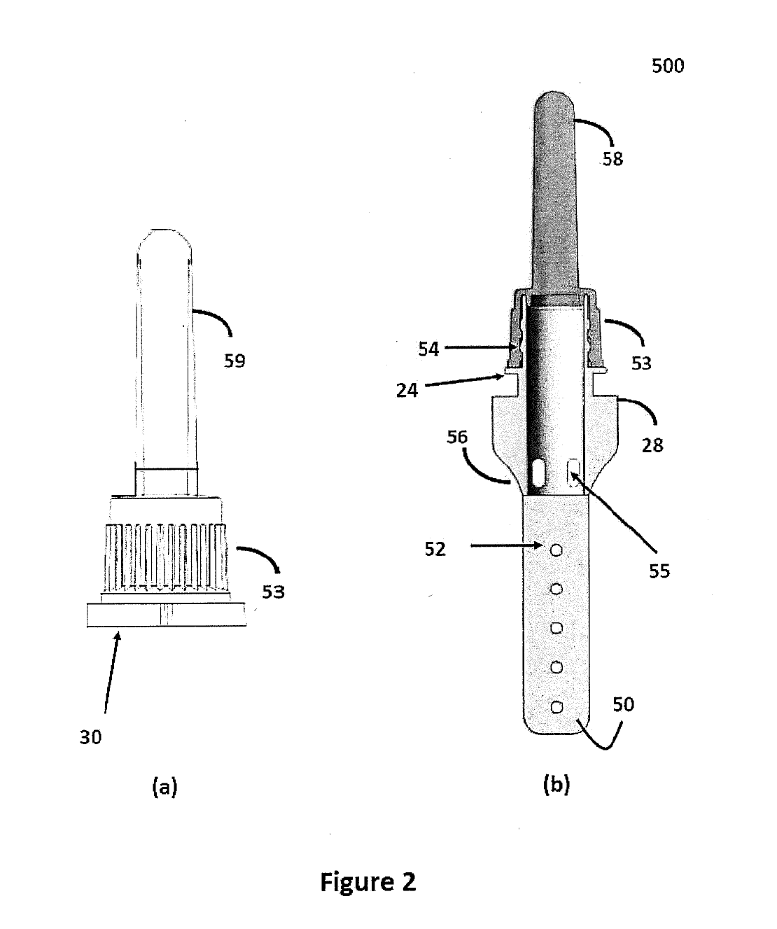

One example of an ice cream stick assembly 500 is illustrated in FIG. 2(b). The assembly may include an ice stick 50, described in FIG. 1, and a “stick cap” closure 30, shown in FIG. 2(a). In one embodiment, the ice stick 50 may include platform wings 56 surrounding the cylindrical upper portion of the stick 50. The stick cap closure 30 may include an upper portion, where a logo location 59 may be provided, and a lower portion, which is a stick cap crown 53, used for attachment. The internal portion of the crown 53 may include an interior distal stick cap lock well 54 attached to the lock notch 21 in order to couple to the ice cream “stick spout” 20. The lock notch 21 may create a sealed connection with the lock well 54.

Once reversed upside down, stick cap handle 58 of the stick cap closure 30 may be used for holding the frozen confection. The frozen edible content (not shown in FIG. 2) may be supported by the ice stick 50 of the ice cream “stick spout” 20. The edible content may lean on the spout stick base 27, as shown in FIG. 1.

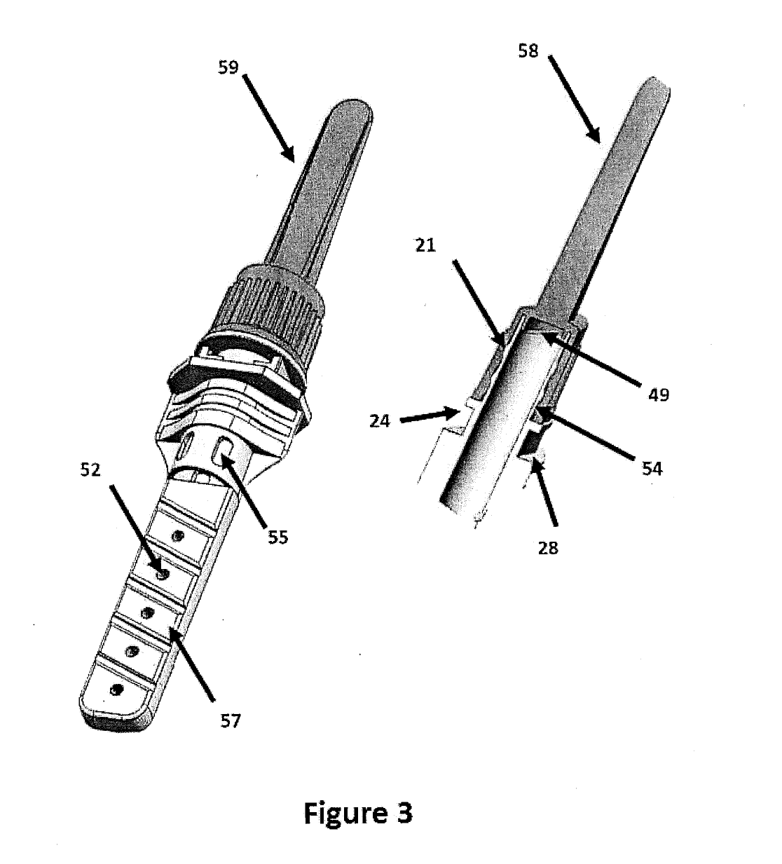

The spout stick 20 may have an inner diameter of 15 to 30 mm or may be of any other dimensions deemed suitable. In one embodiment, the product may be formed with a filling hole of the ice cream stick assembly 500 having an inner diameter of 8 to 9 mm wherein the contents are injected. Filling only the liquid-state ingredients allows manufacture of the product in the form of pouch shape in its liquid state only. The edible ingredients are not frozen until the consumer freezes the pouch. The contents of the frozen dessert may be adjusted in thickness in order to prevent leakage through a seal 49 shown in FIG. 3, where the lock notch 21 is connected to the lock well 54.

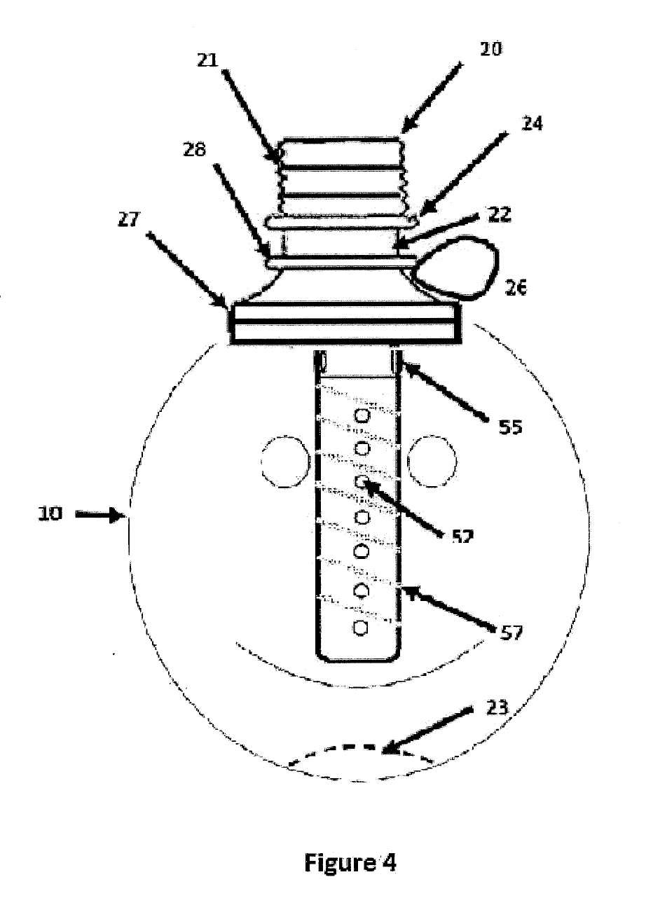

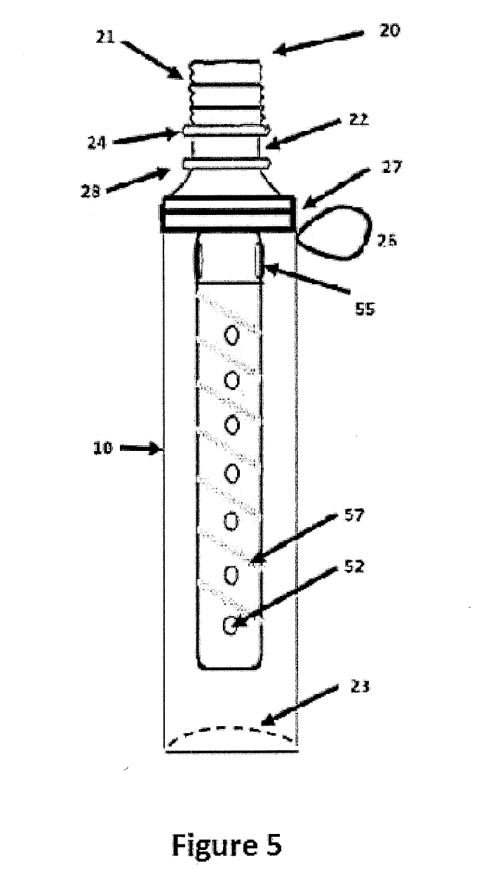

The pouches may take a variety of shapes and may be of different sizes. One of the shapes of the pouch bag 10 may be elliptical, as shown in FIG. 1. In another embodiment, the pouch bag may be designed according to a character shape pouch, as shown in FIG. 4. The bag 10 may have any feasible relative proportions in terms of length, width or thickness, as illustrated in a rocket shape pouch of FIG. 5.

The above described pouches save retailers freezer space and can become a novelty gourmet Italian Ice bar on the shelf, stored at a room temperature, for example. Accordingly, embodiments of the current invention provide an ice cream stick spout pouch that may be used for Italian Ice and juices for consumers to freeze prior to eating.

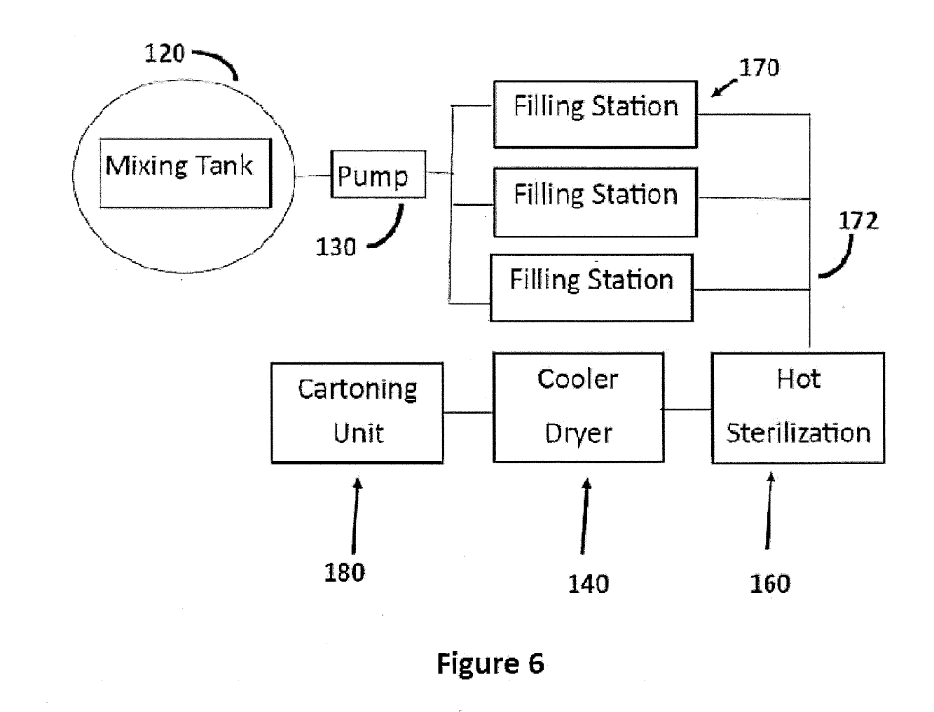

FIG. 6 is a block diagram of a spout stick pouch manufacturing device according to an embodiment of the present invention. Ingredients, such as various types of sugar, flavoring and other ingredients, may be blended by an ingredient material supplying unit and supplied to a mixing tank 120. The injection rate may be based upon the size of the pouch bag 10. The common size of the pouch bag is 2.75 oz or 82 mL, and larger sizes may be 90 mL, or 120 mL, for example. After punching the bag with a cap stick, the filling rate may be approximately 60 pouches per minute. The temperature of the dessert novelty ingredients discharged from the fillers may be −68 to 72° F.

The ingredient material supplying unit (not shown) may supply Italian Ice flavored material or Gelato from an external source, when the ingredients may be stored and subsequently agitated in the mixing tank 120. The agitator in the tank 120 may comprise a motor with an agitating axis connected to the motor and agitating blades formed on an outer circumference of the agitating axis (not shown in the drawing). The agitator may continuously operate to prevent several materials from being separated from each other and precipitated. One example of the ingredient mixing tank 120 may have a capacity up to 2,000 gallons.

The tank 120 may mix the Italian Ice ingredients, and the mixture may then be pumped by a stainless steel lobe pump 130 to filling stations 170, which fill each pouch made of, for example, laminated polypropylene. The pressure of the pump 130 may be 20 to 35 psi.

Next, the liquid edible content may be injected into stick spout pouches at a rate according to pouch size and shape, while attaching a permanent stick cap to complete the manufacturing operation. The ingredients for Italian Ice or juices can be injected through the inner diameter of the spout stick of the spout pouch. The inner diameter may be 8 to 9 mm or any other dimension deemed appropriate.

Upon completion of filling each pouch, a stick cap is punched directly onto each spout stick for permanent closure. An assembly belt 172 may then transport the sealed pouches through a hot sterilization unit 160, which may then be dried in a cooler dryer 140 prior to being stored in a carton unit 180.

The edible content may be stored in a pouch bag made of laminated polypropylene. The pouch bag may be a combination of polyester, aluminum, polyethylene and polypropylene. The material in contact with the edible content may be such that it doesn't impart taste to the confection and it may peel easily from the frozen confection. An example of such material is aluminum, which may be used for an aluminum foil that may accommodate the edible content. A lamination layer may be the external layer of the pouch bag and it may cover the polyethylene graphic print.

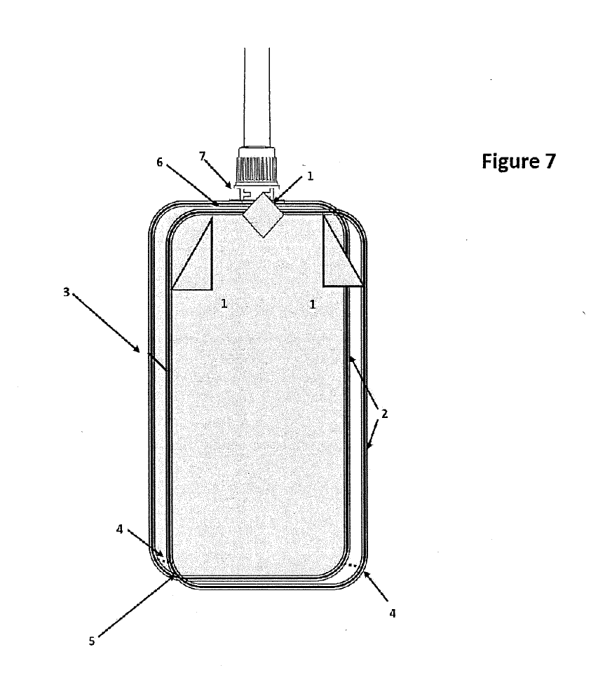

Moreover, once the confection is frozen and prepared for consumption, the pouch bag may be removed in a variety of ways. One example of the pouch bag removal is shown in FIG. 7, where peel back tabs 1 are used for the bag to be peeled away from the frozen confection. The bag may further include sealed edges 2 and pinched seams 4. A fruit bar or square effect may be created by a side gusset 3, a bottom flattened gusset 5, and a top gusset 6. The bag may be sealed to the ice cream stick assembly at a base spout fitment 7.

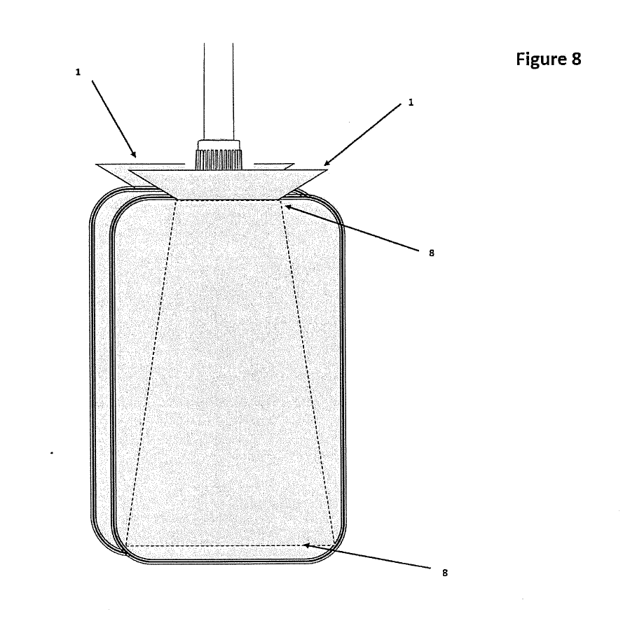

In an example of the stick-spout-pouch illustrated in FIG. 8, the peel back tabs 1 are removed first along pre-perforated lines 8, and the remainder of the pouch bag would follow.

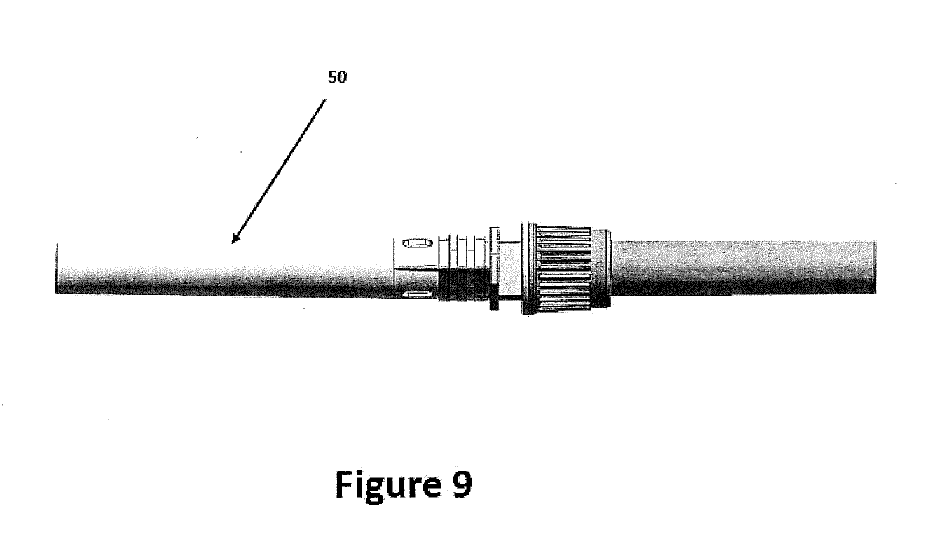

In the embodiment shown in FIG. 2(b), thickness of the ice stick 50 in one direction is considerably smaller than its width in perpendicular direction. Accordingly, the ice stick 50 is substantially flat in shape. However, the ice stick 50 can also be cylindrical in shape, as depicted in FIG. 9, or of any other shape deemed suitable.

Although the various components of the present invention may be described separately, in implementation, they do not necessarily exist as separate elements. The various functions and capabilities disclosed herein may be performed by separate units or be combined into a single unit. Further, the division of function between the units can vary. Furthermore, the functional distinctions that are described herein may be integrated in various ways.

The foregoing description and examples have been set forth merely to illustrate the invention and are not intended to be limiting. Each of the disclosed aspects and embodiments of the present invention may be considered individually or in combination with other aspects, embodiments, and variations of the invention. Modifications of the disclosed embodiments incorporating the spirit and substance of the invention may occur to persons skilled in the art and such modifications are within the scope of the present invention.

What is claimed is:

1. A confection containing device comprising:
a stick-spout-pouch assembly; and
a stick cap;
wherein the stick-spout-pouch assembly includes:
a latching portion integral with a stick portion, and
a pouch bag attached to the latching portion,
wherein the stick cap attaches to the latching portion of the stick-spout-pouch assembly, and
wherein the pouch bag contains the confection in a non-frozen state surrounding the stick portion of the stick-spout-pouch assembly.

2. The confection containing device of claim 1, wherein the pouch bag of the stick-spout-pouch assembly is sealed to the latching portion of the stick-spout-pouch assembly.

3. The confection containing device of claim 1, wherein the stick cap attaches to the latching portion of the stick-spout-pouch assembly by a sealed connection.

4. The confection containing device of claim 1, wherein the pouch bag is filled with the confection in a liquid state through at least one opening on the stick-spout-pouch assembly.

5. The confection containing device of claim 4, wherein the at least one opening is on the latching portion of the stick-spout-pouch assembly.

6. The confection containing device of claim 1, wherein the non-frozen confection changes state of aggregation from liquid to frozen when exposed to a freezing temperature.

7. The confection containing device of claim 6, wherein the pouch bag peels off of the stick-spout-pouch assembly when the confection is frozen.

8. The confection containing device of claim 7, wherein the frozen confection is supported by the stick portion of the stick-spout-pouch when the pouch bag is peeled off.

9. The confection containing device of claim 6, wherein the stick cap is shaped to be elongated for holding the confection containing device when the confection is frozen.

10. The confection containing device of claim 1, wherein the stick portion is shaped to be an elongated stick.

11. The confection containing device of claim 1, wherein the stick portion is shaped to be an elongated cylinder.

12. The confection containing device of claim 1, wherein the stick portion of the stick-spout-pouch assembly includes at least one aperture.

13. The confection containing device of claim 1, wherein the stick portion of the stick-spout-pouch assembly includes at least one groove.

14. The confection containing device of claim 1, wherein components of the device are made of plastics.

15. The confection containing device of claim 4, wherein the at least one opening on the stick-spout-pouch assembly communicates with an opening parallel to a longitudinal axis of the stick-spout-pouch assembly and an opening perpendicular to the longitudinal axis of the stick-spout-pouch assembly.

16. The confection containing device of claim 1, wherein the pouch bag is elliptical.

17. The confection containing device of claim 1, wherein the pouch bag is substantially circular.

18. The confection containing device of claim 1, wherein the pouch bag is rectangular.

19. A confection containing device comprising:
a stick-spout-pouch assembly, wherein the stick-spout-pouch assembly includes:
a latching portion integral with a stick portion, and
a pouch bag attached to the latching portion, wherein the stick-spout-pouch assembly includes an opening allowing the confection, in a liquid state, to be introduced into the pouch bag and surround the stick portion.

20. A method of making a confection that is sold in stores, comprising:
blending confection ingredients in a supplying unit and supplying the confection ingredients to a mixing tank;
pumping a mixture from the mixing tank to a plurality of filling stations;
filling a plurality of sealed pouches with the mixture pumped into the plurality of filling stations;
transporting the plurality of sealed pouches through a hot sterilization unit;
drying the plurality of sealed pouches by a cooler dryer; and
storing the plurality of sealed pouches in a storage unit.
